(19) United States
(12) Patent Application Publication
(10) Pub. No.: US 2018/0320019 A1
(43) Pub. Date: Nov. 8, 2018

(54) MULTI-LAYER COATING STRUCTURE HAVING A THERMALLY LATENT CATALYST

(71) Applicant: Covestro Deutschland AG, Leverkusen (DE)

(72) Inventors: Jan Weikard, Leverkusen (DE); Tanja Hebestreit, Wipperfürth (DE); Frank Richter, Leverkusen (DE)

(21) Appl. No.: 15/776,109

(22) PCT Filed: Nov. 18, 2016
(86) PCT No.: PCT/EP2016/078160

§ 371 Date: May 15, 2018

(30) Foreign Application Priority Data
Nov. 20, 2015 (EP) EP15195521.8

(51) Int. Cl. C09D 175/04; C09D 5/00; C09D 5/08; C08G 18/73; C08G 18/24; B05D 7/00; B05D 1/36

(52) U.S. Cl. CPC C09D 175/04; C09D 5/002; C09D 5/08; C08G 2150/90; C08G 18/242; B05D 7/532; B05D 1/36; C08G 18/73

(57) ABSTRACT

The invention relates to a method for producing a multi-layer coating structure, comprising the following steps: a) providing a substrate; b) applying at least one base-coat layer, wherein the base-coat layer is substantially free of melamine and derivatives thereof; c) applying at least one clear-coat and/or top-coat layer, comprising at least one polyisocyanate, at least one NCO-reactive compound, and at least one thermally latent catalyst; d) waiting for at least 30 s after step c) such that a film can form; e) curing the multi-layer coating structure while supplying heat. The invention further relates to the multi-layer coating structure that can be obtained from the method according to the invention, to the use of the multi-layer coating structure to coat substrates, and to substrates coated with the multi-layer coating structure.

### CROSS REFERENCE TO RELATED APPLICATIONS

This application is a national stage application under 35 U.S.C. § 371 of PCT/EP2016/078160, filed Nov. 18, 2016, which claims priority to European Application No. 15195521.8, filed Nov. 20, 2015, both of which are incorporated by reference herein.

### FIELD OF THE INVENTION

The present invention relates to a process for producing a multilayer paint system, for example for automobile chassis, which leads to multilayer paint systems having good interlayer adhesion at low curing temperatures, to the multilayer paint system obtainable therefrom, and to the use of the multilayer paint system for coating of substrates and to substrates coated with the multilayer paint system.

### BACKGROUND OF THE INVENTION

In the painting of high-quality goods, for example automobiles, the paint is usually applied in multiple layers. In multilayer paint systems of this kind for automobile chassis, a primer is first applied, which, according to the substrate, is intended to improve the adhesion between the substrate and the subsequent layers, and also serves to protect the substrate from corrosion if it is prone to corrosion. In addition, the primer ensures an improvement in the surface characteristics, by covering over any roughness and structure present in the substrate. Especially in the case of metal substrates, primer-surfacer is often applied to the primer, the task of which is to further improve the surface characteristics and to improve the propensity to stonechipping. Typically one or more coloring and/or effect layers are applied to the primer-surfacer, which are referred to as the basecoat. Finally, a highly crosslinked clearcoat is generally applied to the basecoat, which ensures the desired shiny appearance and protects the paint system from environmental effects.

To increase the stability of the overall paint system, the basecoat, as well as being physically dried, is also chemically crosslinked. Cost-effective crosslinkers used are especially derivatives of melamine. However, these have to be cured together with the clearcoat at temperatures well above 120° C.

Since further savings in fuel consumption entail the use of lightweight construction materials in automobile construction, however, it is becoming increasingly important to cure paints also at low temperatures below 120° C., especially below 100° C., in order to be able to paint and cure not only pure metal substrates but also thermoplastics or composite materials that are not dimensionally stable at higher temperatures.

There has already been a description of migration of polyisocyanates from the clearcoat layer at high curing temperatures (140° C.) into the basecoat and contribution to the crosslinking thereof (W. P. Öchsner, R. Nothhelfer-Richter, final report from the Forschungsinstitut für Pigmente und Lacke e.V. [Research Society for Pigments and Coatings], Stuttgart, Germany, “Bestimmung der Haftfestigkeit zwischen Klarlack- und Wasserbasislackschicht und Untersuchung der Wechselwirkungen an der Grenzfläche” [Determining the Bond Strength between Clearcoat and Aqueous Basecoat Layer and Examining the Interactions at the Interface], 10.26.2009).

Such a diffusion effect has also been described for low temperatures (<60° C.), for example in the case of automotive repair paints, but this is much less marked within the same period of time compared to the industrial process at high temperatures.

In the case of faster industrial curing processes, diffusion is distinctly reduced, and so adequate crosslinking of the basecoat no longer takes place, which has an adverse effect on the stability of the overall paint system. Even the customary basecoat crosslinking with melamine derivatives, at temperatures below 120° C., does not lead to adequate crosslinking of the basecoat layer, unless the typically polyisocyanate-free basecoat is used in the form of a two-component system comprising polyisocyanate and NCO-reactive (isocyanate-reactive) compound and is only mixed on application. The use of a two-component basecoat comprising polyisocyanate and isocyanate-reactive compound, however, is disadvantageous for reasons of inadequate storage stability and for reasons of cost.

WO 2014/009221 and WO 2014/009220 describe polyisocyanate crosslinkers that are said to have improved diffusion into the basecoat. This is achieved by incorporation of hydrophilic groups into the crosslinker or use of particular crosslinkers having lower viscosity. However, the improved diffusion effect brought about as a result is not sufficiently strong to assure efficient crosslinking of the basecoat at temperatures below 120° C. Another disadvantage of the low molecular weight crosslinker molecules is that they have low functionality and/or have been hydrophilically modified, which means that the paint layers crosslinked therewith have poor weathering or chemical resistances.

In the development of multilayer systems composed of basecoat and clearcoat and/or topcoat that cure at lower temperatures, the challenge is thus to find a system that enables adequate crosslinking of the basecoat layer while maintaining the oven times of below 45 minutes that are customary for the curing of systems that cure at high temperatures, since an extension of the customary oven time is undesirable for economic reasons.

A general option for achieving rapid crosslinking of a paint system that cures at low temperatures is to increase the rate of the crosslinking reaction through the use of catalysts. However, improvements in the crosslinking rate resulting from the use of catalysts are regrettably associated with an unacceptable deterioration in the paint appearance, since the crosslinking reaction of the catalyzed paint system already proceeds during the leveling and film-forming phase. This causes an irregular surface of the cured paint layer.

The running of the crosslinking reaction of the catalyzed paint system during the leveling and film-forming phase can be minimized to some degree by careful adjustment of the catalyst concentration. Typically, organotin catalysts such as dialkyltin dialkoxides and dialkanoates, especially dibutyltin dilaurate, are used in paint systems. However, organotin catalysts have the disadvantage of having an unfavorable physiological profile and hence have become the subject of criticism.

Alternative catalysts that are now being used therefore include derivatives of various metals, for example bismuth, zirconium, titanium or zinc, but these frequently have lower activities compared to the organotin catalysts and/or are not as versatile.

### SUMMARY OF THE INVENTION

Proceeding from the art elucidated above, the present invention provides a process for producing a multilayer paint system that enables a sufficiently strong diffusion effect of the clearcoat crosslinker into the basecoat at low curing temperatures, such that the basecoat can be crosslinked even without addition of a melamine crosslinker with short oven dwell times.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

Any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112(a), and 35 U.S.C. § 132(a). The various embodiments disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

The invention provides a process for producing a multilayer paint system comprising the following steps:
a) applying to a substrate at least one basecoat layer, the basecoat layer being essentially free of melamine and derivatives thereof;
b) applying to the substrate at least one clearcoat and/or topcoat layer, comprising at least one polyisocyanate, at least one NCO-reactive compound and at least one thermally latent catalyst;
c) waiting for at least 30 s after step b) to allow a film to form;
d) curing the multilayer paint system with heat.

It has been found that, surprisingly, a process of this kind enables good crosslinking of the multilayer paint system even without addition of a melamine crosslinker in the base layer at low temperatures well below 120° C. with oven dwell times of well below 45 minutes. Thus, the measurements by the methods described in the Experimental show that a multilayer paint system comprising a melamine-free basecoat layer and a clearcoat system with a thermally latent catalyst after drying at 100° C. for 30 minutes attains the industrially required level of crosslinking and hence meets current demands on chemical resistance and scratch resistance.

Moreover, the multilayer paint systems produced by the process of the invention using a thermally latent catalyst exhibit improved intermediate layer adhesion compared to the dibutyltin dilaurate-catalyzed systems known from the prior art. Without wishing to be bound to scientific theories, the improved intermediate layer adhesion appears to be based on the fact that the thermally latent catalysis makes more time available for diffusion of the polyisocyanate into the basecoat layer. The process of the invention thus allows good crosslinking of the multilayer paint system at low temperatures with short oven dwell times and can advantageously be used for application of multilayer paint systems even to thermally sensitive substrates such as thermoplastics or composite materials that are not deformation-stable at relatively high temperatures in an industrial manufacturing process.

The process of the invention therefore enables the common painting of pure metal substrates and thermoplastics or composite materials. A further advantage of the process of the invention is that the painting process is energy-efficient and inexpensive by virtue of the much lower temperatures used compared to the standard processes.

The invention further provides a multilayer paint system obtainable by the process of the invention, for the use of the multilayer paint system for coating of substrates, and substrates coated with this multilayer paint system.

In the context of the present invention, multilayer paint systems are understood to mean those paint systems comprising at least one basecoat layer and at least one clearcoat and/or topcoat layer. Basecoat layer, topcoat layer and clearcoat layer may be the same or different in terms of their chemical composition. Preferably, basecoat layer, topcoat layer and clearcoat layer are different in terms of their chemical composition.

According to the invention, both topcoat layer and the clearcoat layer comprise at least one NCO-reactive (isocyanate-reactive) compound. An NCO-reactive compound is understood to mean a compound that can react with polyisocyanates to give polyisocyanate polyaddition compounds, especially polyurethanes. In the context of the invention, polyisocyanates are compounds having at least two isocyanate groups per molecule.

NCO-reactive compounds used may be any compounds known to those skilled in the art that have a mean OH or NH functionality of at least 1.5. These may, for example, be low molecular weight diols (e.g. ethane-1,2-diol, propane-1,3- or -1,2-diol, butane-1,4-diol), triols (e.g. glycerol, trimethylolpropane) and tetraols (e.g. pentaerythritol), short-chain polyamines, but also polyhydroxyl compounds such as polyether polyols, polyester polyols, polyurethane polyols, polysiloxane polyols, polycarbonate polyols, polyetherpolyamines, polybutadiene polyols, polyacrylate polyols and/or polymethacrylate polyols and copolymers thereof, called polyacrylate polyols hereinafter.

The polyhydroxyl compounds preferably have mass-average molecular weights Mw>500 daltons, measured by means of gel permeation chromatography (GPC) against a polystyrene standard, more preferably between 800 and 100 000 daltons, especially between 1000 and 50 000 daltons.

The polyhydroxyl compounds preferably have an OH number of 30 to 400 mg KOH/g, especially between 100 and 300 KOH/g. The hydroxyl number (OH number) indicates how many mg of potassium hydroxide are equivalent to the amount of acetic acid bound by 1 g of substance in the acetylation. In the determination, the sample is boiled with acetic anhydride/pyridine, and the acid formed is titrated with potassium hydroxide solution (DIN 53240-2).

The glass transition temperatures, measured with the aid of DSC measurements according to DIN EN ISO 1 1357-2, of the polyhydroxyl compounds are preferably between −150 and 100° C., more preferably between −120° C. and 80° C.

Polyether polyols are obtainable in a manner known per se, by alkoxylation of suitable starter molecules under base catalysis or using double metal cyanide compounds (DMC compounds). Suitable starter molecules for the preparation of polyether polyols are, for example, simple low molecular weight polyols, water, organic polyamines having at least two N-H bonds, or any desired mixtures of such starter molecules.

Preferred starter molecules for preparation of polyether polyols by alkoxylation, especially by the DMC process, are especially simple polyols such as ethylene glycol, propylene 1,3-glycol and butane-1,4-diol, hexane-1,6-diol, neopentyl glycol, 2-ethylhexane-1,3-diol, glycerol, trimethylolpropane, pentaerythritol, and low molecular weight hydroxyl-containing esters of such polyols with dicarboxylic acids of the type specified hereinafter by way of example, or low molecular weight ethoxylation or propoxylation products of such simple polyols, or any desired mixtures of such modified or unmodified alcohols. Alkylene oxides suitable for the alkoxylation are especially ethylene oxide and/or propylene oxide, which can be used in the alkoxylation in any sequence or else in a mixture.

Suitable polyester polyols are described, for example, in EP-A-0 994 1 17 and EP-A-1 273 640. Polyester polyols can be prepared in a known manner by polycondensation of low molecular weight polycarboxylic acid derivatives, for example succinic acid, adipic acid, suberic acid, azelaic acid, sebacic acid, dodecanedioic acid, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimer fatty acid, trimer fatty acid, phthalic acid, phthalic anhydride, isophthalic acid, terephthalic acid, citric acid or trimellitic acid, with low molecular weight polyols, for example ethylene glycol, diethylene glycol, neopentyl glycol, hexanediol, butanediol, propylene glycol, glycerol, trimethylolpropane, 1,4-hydroxymethylcyclohexane, 2-methylpropane-1,3-diol, butane-1,2,4-triol, triethylene glycol, tetraethylene glycol, polyethylene glycol, dipropylene glycol, polypropylene glycol, dibutylene glycol and polybutylene glycol, or by ring-opening polymerization of cyclic carboxylic esters such as ϵ-caprolactone. In addition, it is also possible to polycondense hydroxycarboxylic acid derivatives, for example lactic acid, cinnamic acid or ω-hydroxycaproic acid to give polyester polyols. However, it is also possible to use polyester polyols of oleochemical origin. Such polyester polyols can be prepared, for example, by full ring-opening of epoxidized triglycerides of an at least partly olefinically unsaturated fatty acid-containing fat mixture with one or more alcohols having 1 to 12 carbon atoms and by subsequent partial transesterification of the triglyceride derivatives to alkyl ester polyols having 1 to 12 carbon atoms in the alkyl radical.

Polyurethane polyols are preferably prepared by reaction of polyester prepolymers with suitable di- or polyisocyanates and are described, for example, in EP-A-1 273 640. Suitable polysiloxane polyols are described, for example, in WO-A-01/09260, and the polysiloxane polyols cited therein can preferably be used in combination with further polyhydroxyl compounds, especially those having higher glass transition temperatures.

The polyacrylate polyols that are very particularly preferred in accordance with the invention are generally copolymers and preferably have mass-average molar masses Mw between 1000 and 20 000 daltons, especially between 5000 and 10 000 daltons, measured in each case by means of gel permeation chromatography (GPC) against a polystyrene standard. The glass transition temperature of the copolymers is generally between −100 and 100° C., especially between −50 and 80° C. (measured by means of DSC measurements according to DIN EN ISO 1 1357-2).

The polyacrylate polyols preferably have an OH number of 60 to 250 mg KOH/g, especially between 70 and 200 KOH/g, and an acid number between 0 and 30 mg KOH/g. The acid number here indicates the number of mg of potassium hydroxide which is used for neutralization of 1 g of the respective compound (DIN EN ISO 21 14).

The preparation of suitable polyacrylate polyols is known to those skilled in the art. They are obtained by free-radical polymerization of olefinically unsaturated monomers having hydroxyl groups or by free-radical copolymerization of olefinically unsaturated monomers having hydroxyl groups with optionally other olefinically unsaturated monomers, for example ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, amyl acrylate, amyl methacrylate, hexyl acrylate, hexyl methacrylate, ethylhexyl acrylate, ethylhexyl methacrylate, 3,3,5-trimethylhexyl acrylate, 3,3,5-trimethylhexyl methacrylate, stearyl acrylate, stearyl methacrylate, lauryl acrylate or lauryl methacrylate, cycloalkyl acrylates and/or cycloalkyl methacrylates, such as cyclopentyl acrylate, cyclopentyl methacrylate, isobornyl acrylate, isobornyl methacrylate or especially cyclohexyl acrylate and/or cyclohexyl methacrylate. Suitable olefinically unsaturated monomers having hydroxyl groups are especially 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate and especially 4-hydroxybutyl acrylate and/or 4-hydroxybutyl methacrylate.

Further monomer units used for the polyacrylate polyols may be vinylaromatic hydrocarbons, such as vinyltoluene, alpha-methylstyrene or especially styrene, amides or nitriles of acrylic acid or methacrylic acid, vinyl esters or vinyl ethers, and in minor amounts especially acrylic acid and/or methacrylic acid.

In a preferred embodiment of the invention, the NCO-reactive compound present in the clearcoat and/or topcoat layer is a polyhydroxyl compound. Preferably, the polyhydroxyl compound is selected from the group consisting of polyester polyols, polyurethane polyols, polysiloxane polyols, polycarbonate polyols, polyacrylate polyols and mixtures thereof.

The basecoat layer is formed from basecoat formulations that are known, which may be used either in solventborne or in aqueous form.

According to the invention, the basecoat layer is essentially free of melamine and derivatives thereof. In this context, “essentially free” means more particularly that melamine and derivatives thereof are present in the basecoat layer in amounts of less than 5% by weight, preferably less than 3% by weight, more preferably less than 1% by weight, based on the total weight of the nonvolatile components of the basecoat layer. Melamine or derivatives thereof present in these amounts in the basecoat layer do not make a significant contribution to the cros slinking of the basecoat layer in the course of curing with supply of heat in step d) of the process of the invention.

In a preferred embodiment of the invention, the basecoat layer is free of melamine and derivatives thereof.

In embodiments in which, for example, a further improvement in interlayer adhesion and an even higher degree of cros slinking of the basecoat layer is important, it has been found to be advantageous when the basecoat layer of the invention comprises at least one NCO-reactive compound. NCO-reactive compounds suitable for the basecoat layer are polyether polyols, polycarbonate polyols, polyester polyols, polyacrylate polyols, polyurethane polyols, polyacrylate polyols, as already described further up for the clearcoat layer. The NCO-reactive compound used in the basecoat layer is preferably one or more selected from polyester polyols, polyacrylate polyols and/or polyurethane polyols.

In a preferred embodiment of the invention, the basecoat layer comprises at least one NCO-reactive compound.

In a further preferred embodiment, the basecoat is a one-component coat and has no pot life. In this context, “no pot life” means that the application-ready basecoat is storage-stable for more than 7 days, preferably more than 2 weeks, more preferably more than 4 weeks, i.e. can be used with the same properties as freshly prepared after 7 days, 2 weeks or 4 weeks.

Compositions of, demands on and processing of basecoats are described, for example, in the specifications from the automobile companies or else, for example, in the article “Eine Frage der Einstellung” [A Question of Attitude], published in “Farbe and Lack 07/2003” (Vincentz-Verlag). Additionally in U. Poth, Automotive Coatings Formulation, Vincentz-Verlag 2008, ISBN 9783866309043 or U. Kuttler, Principles of Automotive OEM Coatings, Allnex Belgium S.A., downloaded on Nov. 3, 2015 from http://www.farbeundlack.de/contont/download/26319016322245/file/01 Kuttler.pdf. Formulations are also described in W. P. Öchsner, R. Nothhelfer-Richter, final report from the Forschungsinstitut fur Pigmente und Lacke e.V., Stuttgart, D E, “Bestimmung der Haftfestigkeit zwischen Klarlack- und Wasserbasislackschicht und Untersuchung der Wechselwirkungen an der Grenzflache”, Oct. 26, 2009.

As well as the at least one NCO-reactive compound, the clearcoat and/or topcoat layer to be applied in step b) in accordance with the invention comprises at least one polyisocyanate.

Polyisocyanates used here may in principle be any polyisocyanates known to the person skilled in the art to be suitable for the preparation of polyisocyanate polyaddition products, especially polyurethanes, especially the group of the organic aliphatic, cycloaliphatic, araliphatic and/or aromatic polyisocyanates having at least two isocyanate groups per molecule and mixtures thereof. Examples of polyisocyanates of this kind are di- or triisocyanates, for example butane 1,4-diisocyanate, pentane 1,5-diisocyanate (pentamethylene diisocyanate, PDI), hexane 1,6-diisocyanate (hexamethylene diisocyanate, HDI), 4-isocyanatomethyloctane 1,8-diisocyanate (triisocyanatononane, TIN), 4,4′-methylenebis(cyclohexyl isocyanate) (H₁₂MDI), 3,5,5-trimethyl-1-isocyanato-3-isocyanatomethylcyclohexane (isophorone diisocyanate, IPDI), 1,3- and 1,4-bis(isocyanatomethyl)cyclohexane (H₆XDI), naphthalene 1,5-diisocyanate, diisocyanatodiphenylmethane (2,2′-, 2,4′- and 4,4′-MDI or mixtures thereof), diisocyanatomethylbenzene (tolylene 2,4- and 2,6-diisocyanate, TDI) and technical grade mixtures of the two isomers, and also 1,3-bis(isocyanatomethyl)benzene (XDI), 3,3′-dimethyl-4,4′-biphenyl diisocyanate (TODI), paraphenylene 1,4-diisocyanate (PPDI) and cyclohexyl diisocyanate (CHDI) and the oligomers of higher molecular weight that are obtainable individually or in a mixture from the above and have biuret, uretdione, isocyanurate, iminooxadiazinedione, allophanate, urethane and carbodiimide/uretonimine structural units. Preference is given to using polyisocyanates based on aliphatic and cycloaliphatic diisocyanates.

In a particular embodiment of the invention, the polyisocyanate present in the clearcoat and/or topcoat layer is an aliphatic and/or cycloaliphatic polyisocyanate.

In another preferred embodiment of the invention, the polyisocyanate present in the clearcoat and/or topcoat layer is a derivative of hexamethylene diisocyanate and/or of pentamethylene diisocyanate, especially a hexamethylene diisocyanate trimer and/or a pentamethylene diisocyanate trimer.

The ratio of polyisocyanates to NCO-reactive compounds in the clearcoat or topcoat layer, based on the molar amounts of the polyisocyanate groups relative to the NCO-reactive groups, is from 0.8:1.0 to 2.0:1.0. Preference is given to a ratio of 1.0:1.0 to 1.5:1.0 Particular preference is given to a ratio of 1.05:1.0 to 1.25:1.0

Both the basecoat layer and the clearcoat and/or topcoat layer may additionally comprise customary auxiliaries and additions in effective amounts. Effective amounts for solvents are preferably up to 150% by weight, more preferably up to 100% by weight and especially up to 70% by weight, based in each case on the nonvolatile constituents of the respective coating composition (basecoat, topcoat or clearcoat). Effective amounts of other additives are preferably up to 25% by weight, more preferably up to 10% by weight and especially up to 5% by weight, based in each case on the nonvolatile constituents of the respective coating composition (basecoat, topcoat or clearcoat).

Examples of suitable auxiliaries and additions are especially light stabilizers such as UV absorbers and sterically hindered amines (HALS), and also stabilizers, fillers and antisettling agents, defoaming, anticratering and/or wetting agents, leveling agents, film-forming auxiliaries, reactive diluents, solvents, substances for rheology control, slip additives and/or components which prevent soiling and/or improve the cleanability of the cured paints, and also flatting agents.

The use of light stabilizers, especially of UV absorbers, for example substituted benzotriazoles, S-phenyltriazines or oxalanilides, and of sterically hindered amines, especially having 2,2,6,6-tetramethylpiperidyl structures—referred to as HALS—is described by way of example in A. Valet, Lichtschutzmittel für Lacke [Light Stabilizers for Coatings], Vincentz Verlag, Hanover, 1996.

Stabilizers, for example free-radical scavengers and other polymerization inhibitors such as sterically hindered phenols, stabilize paint components during storage and are intended to prevent discoloration during curing. Acidic stabilizers are also useful for isocyanate-containing components, such as alkyl-substituted partial phosphoric esters and water scavengers such as triethyl orthoformate.

Preferred fillers are those compounds that have no adverse effect on the appearance of the clearcoat or topcoat layer. Examples are nanoparticles based on silicon dioxide, aluminum oxide or zirconium oxide; reference is also made additionally to the Rompp Lexicon »Lacke and Druckfarben« [Coatings and Printing Inks] Georg Thieme Verlag, Stuttgart, 1998, pages 250 to 252.

If there are fillers, flatting agents or pigments in the clearcoat or topcoat, the addition of antisettling agents may be advisable to prevent separation of the constituents in the course of storage.

Wetting and leveling agents improve surface wetting and/or the leveling of coatings. Examples are fluoro surfactants, silicone surfactants and specific polyacrylates. Rheology control additives are important in order to control the properties of the liquid coating on application and in the leveling phase on the substrate and are additives known, for example, from patent specifications WO 94/22968, EP-A-0 276 501, EP-A-0 249 201 or WO 97/12945; crosslinked polymeric microparticles as disclosed, for example, in EP-A-0 038 127; inorganic sheet silicates such as aluminum-magnesium silicates, sodium-magnesium and sodium-magnesium-fluorine-lithium sheet silicates of the montmorillonite type; silicas such as Aerosil®; or synthetic polymers having ionic and/or associative groups such as polyvinyl alcohol, poly(meth)acrylamide, poly(meth)acrylic acid, polyvinylpyrrolidone, styrene-maleic anhydride or ethylene-maleic anhydride copolymers and derivatives thereof, or hydrophobically modified ethoxylated urethanes or polyacrylates.

Suitable solvents should be used in a manner known to the person skilled in the art, matched to the binders used and to the application process. Solvents are intended to dissolve the components used and promote the mixing thereof, and to avoid incompatibilities. In addition, during the application and the curing, they should leave the coating in a manner matched to the running crosslinking reaction, so as to give rise to a solvent-free paint layer with very good appearance and without defects such as popping or pinholes. Useful solvents are especially those employed in the technology of 2-component polyurethane clearcoats or topcoats. Examples are ketones such as acetone, methyl ethyl ketone or hexanone, esters such as ethyl acetate, butyl acetate, methoxypropyl acetate, substituted glycols and other ethers, aromatics such as xylene or Solvent naphtha from Exxon-Chemie, and mixtures of the solvents mentioned.

The topcoat layer and the basecoat may also contain pigments, dyes and/or fillers. The pigments used for this purpose including metallic or other effect pigments, dyes and/or fillers are known to those skilled in the art.

The clearcoat and/or topcoat layer to be applied in step b) of the process of the invention contains at least one thermally latent catalyst. A thermally latent catalyst as used here is especially understood to mean any catalyst that does not accelerate or does not significantly accelerate the crosslinking reaction of the at least one polyisocyanate with the at least one NCO-reactive compound to form a urethane bond below 25° C., especially below 30° C., preferably below 40° C., but significantly accelerates it above 60° C., especially above 70° C. “Does not significantly accelerate” means here that the presence of the thermally latent catalyst in the clearcoat and/or topcoat layer does not have any significant effect below 25° C., especially below 30° C., preferably below 40° C., on the reaction rate of the reaction that proceeds in any case. A significant acceleration is understood to mean that the presence of the thermally latent catalyst has a distinct effect on the reaction rate above 60° C., especially above 70° C., in the clearcoat and/or topcoat layer on the reaction that proceeds in any case. Preferred thermally latent catalysts are inorganic tin-containing compounds having no direct tin-carbon bond.

It has been found to be particularly advantageous in the context of the invention when the thermally latent catalyst used in the clearcoat and/or topcoat layer comprises cyclic tin compounds of the formula I, II or III or mixtures thereof:

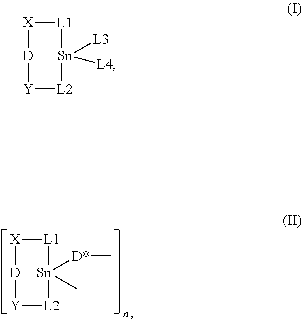

with n>1,

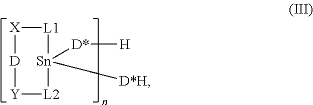

with n>1,
where:
D is —O—, —S— or —N(R1)-
   where R1 is a saturated or unsaturated, linear or branched, aliphatic or cycloaliphatic radical or an optionally substituted aromatic or aliphatic radical which has up to 20 carbon atoms and may optionally contain heteroatoms from the group of oxygen, sulfur, nitrogen, or is hydrogen or the radical

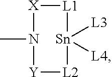

or R1 and L3 together are -Z-L5-;
D* is —O— or —S—;
X, Y and Z are identical or different radicals selected from alkylene radicals of the formulae —C(R2)(R3)-, —C(R2)(R3)-C(R4)(R5)- or —C(R2)(R3)-C(R4)(R5)- C(R6)(R7)- or ortho-arylene radicals of the formulae

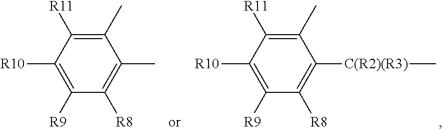

where R2 to R11 are independently saturated or unsaturated, linear or branched, aliphatic or cycloaliphatic or optionally substituted aromatic or araliphatic radicals which have up to 20 carbon atoms and may optionally contain heteroatoms from the group of oxygen, sulfur, nitrogen, or are hydrogen;
L1, L2 and L5 are independently —O—, —S—, —OC(═O)—, —OC(═S), —SC(═O)—, —SC(═S)—, —OS(═O)₂O—, —OS(═O)₂— or —N(R12)—,
   where R12 is a saturated or unsaturated, linear or branched, aliphatic or cycloaliphatic radical or an optionally substituted aromatic or araliphatic radical which has up to 20 carbon atoms and may optionally contain heteroatoms from the group of oxygen, sulfur, nitrogen, or is hydrogen;
L3 and L4 are independently —OH, —SH, —OR13, -Hal, —OC(═O)R14, —SR15, —OC(═S)R16, —OS(═O)₂OR17, —OS(═O)₂R18 or —NR19R20, or L3 and L4 together are -L1-X-D-Y-L2-,
   where R13 to R20 are independently saturated or unsaturated, linear or branched, aliphatic or cycloaliphatic or optionally substituted aromatic or araliphatic radicals which have up to 20 carbon atoms and may optionally contain heteroatoms from the group of oxygen, sulfur, nitrogen, or are hydrogen.

Preferably, D is —N(R1)-.

Preferably, R1 is hydrogen or an alkyl, aralkyl, alkaryl or aryl radical having up to 20 carbon atoms or the radical

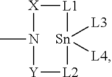

more preferably hydrogen or an alkyl, aralkyl, alkaryl or aryl radical having up to 12 carbon atoms or the radical

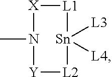

most preferably hydrogen or a methyl, ethyl, propyl, butyl, hexyl or octyl radical, where propyl, butyl, hexyl and octyl are all isomeric propyl,

butyl, hexyl and octyl radicals, or Ph—, CH₃Ph— or the radical

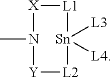

Preferably, D* is —O—.

Preferably, X, Y and Z are the alkylene radicals —C(R2)(R3), —C(R2)(R3)-C(R4)(R5)- or the ortho-arylene radical

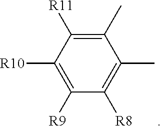

Preferably, R2 to R7 are hydrogen or alkyl, aralkyl, alkaryl or aryl radicals having up to 20 carbon atoms, more preferably hydrogen or alkyl, aralkyl, alkaryl or aryl radicals having up to 8 carbon atoms, even more preferably hydrogen or alkyl radicals having up to 8 carbon atoms, even further preferably hydrogen or methyl.

Preferably, R8 to R11 are hydrogen or aryl radicals having up to 8 carbon atoms, more preferably hydrogen or methyl.

Preferably, L1, L2 and L5 are —NR12-, —S—, —SC(═S)—, —SC(═O)—, —OC(═S)—, —O—, or —OC(═O)—, more preferably —O—, or —OC(═O)—.

Preferably, R12 is hydrogen or an alkyl, aralkyl, alkaryl or aryl radical having up to 20 carbon atoms, more preferably hydrogen or an alkyl, aralkyl, alkaryl or aryl radical having up to 12 carbon atoms, even more preferably hydrogen or a methyl, ethyl, propyl, butyl, hexyl or octyl radical, where propyl, butyl, hexyl and octyl are all isomeric propyl, butyl, hexyl and octyl radicals.

Preferably, L3 and L4 are -Hal, —OH, —SH, —OR13, —OC(═O)R14, where the R13 and R14 radicals have up to 20 carbon atoms, more preferably up to 12 carbon atoms.

More preferably, L3 and L4 are Cl—, MeO—, EtO—, PrO—, BuO—, HexO—, OctO—, PhO—, formate, acetate, propanoate, butanoate, pentanoate, hexanoate, octanoate, laurate, lactate or benzoate, where Pr, Bu, Hex and Oct are all isomeric propyl, butyl, hexyl and octyl radicals, even further preferably Cl—, MeO—, EtO—, PrO—, BuO—, HexO—, OctO—, PhO—, hexanoate, laurate or benzoate, where Pr, Bu, Hex and Oct are all isomeric propyl, butyl, hexyl and octyl radicals.

Preferably, R15 to R20 are hydrogen or alkyl, aralkyl, alkaryl or aryl radicals having up to 20 carbon atoms, more preferably hydrogen or alkyl, aralkyl, alkaryl or aryl radicals having up to 12 carbon atoms, even more preferably hydrogen or methyl, ethyl, propyl, butyl, hexyl or octyl radicals, where propyl, butyl, hexyl and octyl are all isomeric propyl, butyl, hexyl and octyl radicals.

The L1-X, L2-Y and L5-Z units are preferably —CH₂CH₂O—, —CH₂CH(Me)O—, —CH(Me)CH₂O—, —CH₂C(Me)₂O—, —C(Me)₂ CH₂O— or —CH₂C(═O)O—.

The L1-X-D-Y-L2 unit is preferably: HN[CH₂CH₂O—]₂, HN[CH₂CH(Me)O—]₂, HN[CH₂CH(Me)O—][CH(Me)CH₂O—], HN[CH₂C(Me)₂O—]₂, HN[CH₂C(Me)₂O—][C(Me)₂CH₂O—], HN[CH₂C(═O)O—]₂, MeN[CH₂CH₂O—]₂, MeN[CH₂CH(Me)O—]₂, MeN[CH₂CH(Me)O—][CH(Me)CH₂O—], MeN[CH₂C(Me)₂O—]₂, MeN[CH₂C(Me)₂O—][C(Me)₂CH₂O—], MeN[CH₂C(═O)O—]₂, EtN[CH₂CH₂O—]₂, EtN[CH₂CH(Me)O—]₂, EtN[CH₂CH(Me)O—][CH(Me)CH₂O —], EtN[CH₂C(Me)₂₀—]₂, EtN[CH₂C(Me)₂₀—][C(Me)₂CH₂O —], EtN[CH₂C(═O)O—]₂, PrN[CH₂CH₂O—]₂, PrN[CH₂CH(Me)O—]₂, PrN[CH₂CH(Me)O—][CH(Me)C₂O—], PrN[CH₂C(Me)₂O—]₂, PrN[CH₂C(Me)₂O—][C(Me)₂CH₂O—], PrN[CH₂C(═O)O—]₂, BuN[CH₂CH₂O—]₂, BuN[CH₂CH(Me)O—]₂, BuN[CH₂CH(Me)O—][CH(Me)CH₂O—], BuN[CH₂C(Me)₂O—]₂, BuN[CH₂C(Me)₂O—][C(Me)₂C₂O—], BuN[CH₂C(═O)O—]₂, HexN[CH₂CH₂O—]₂, HexN[CH₂CH(Me)O—]₂, HexN[CH₂CH(Me)O—][CH(Me)C₂O—], HexN[CH₂C(Me)₂O—]₂, HexN[CH₂C(Me)₂O—][C(Me)₂C₂O—], HexN[CH₂C(═O)O—]₂, OCtN[CH₂CH₂O—]₂, OctN[CH₂CH(Me)O—]₂, OctN[CH₂CH(Me)O—][CH(Me)C₂O—], OctN[CH₂C(Me)₂O—]₂, OctN[CH₂C(Me)₂o—][C(Me)₂C₂O—], OctN[CH₂C(═O)O—]₂, where Pr, Bu, Hex and Oct may be all isomeric propyl, butyl and octyl radicals, PhN[CH₂CH₂O—]₂, PhN[CH₂CH(Me)O—]₂, PhN[CH₂CH(Me)O—][CH(Me)C₂O—], PhN[CH₂C(Me)₂O—]₂, PhN[CH₂C(Me)₂O—][C(Me)₂C₂O—], PhN[CH₂C(═O)O—]₂,

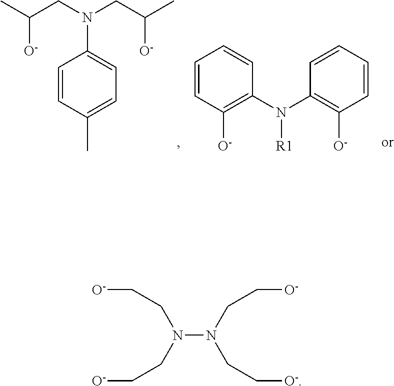

Processes for preparing the thermally latent catalysts suitable in accordance with the invention are described, for example, in: EP 2 900 716 A1, EP 2 900 717 A1, EP 2 772 496 A1, EP 14182806, J. Organomet. Chem. 2009 694 3184-3189, Chem. Heterocycl.Comp. 2007 43 813-834, Indian J. Chem. 1967 5 643-645 and in literature cited therein, the entire disclosure content of which is hereby incorporated by reference.

As is known to the person skilled in the art, tin compounds have a propensity to oligomerize, and so there are often polynuclear tin compounds or mixtures of mono- and polynuclear tin compounds. In the polynuclear tin compounds, the tin atoms are preferably connected to one another via oxygen atoms ('oxygen bridges'). Typical oligomeric complexes (polynuclear tin compounds) form, for example, through condensation of the tin atoms via oxygen or sulfur, for example

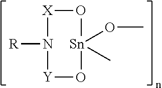

where n>1 (cf. formula II). Cyclic oligomers are frequently encountered in the case of low degrees of oligomerization, linear oligomers with OH or SH end groups in the case of high degrees of oligomerization (cf. formula III).

In one embodiment of the invention, the thermally latent catalyst is selected from the group of mono- and polynuclear tin compounds of the following type:

1,1-di-“R”-5-“organyl”-5-aza-2,8-dioxa-1-stannacyclooctanes,

1,1-di-“R”-5-(N-“organyl”)aza-3,7-di-“organyl”-2,8-dioxa-1-stannacyclooctanes,

1,1-di-“R”-5-(N-“organyl”)aza-3,3,7,7-tetra-“organyl”-2,8-dioxa-1-stannacyclooctanes,

4,12-di-“organyl”-1,7,9,15-tetraoxa-4,12-diaza-8-stannaspiro[7.7]pentadecanes,

4,12-di-“organyl”-2,6,10,14-tetra-“organyl”-1,7,9,15-tetraoxa-4,12-diaza-8-stannaspiro[7.7]pentadecanes,

4,12-di-”organyl”-2,2,6,6,10,10,14,14-octa-“organyl”-1,7,9,15-tetraoxa-4,12-diaza-8-stannaspiro[7.7[pentadecanes,

where “R” is D*, L3 or L4, as defined above, and “organyl” is R1, as defined above.

In a preferred embodiment of the invention, the thermally latent catalyst is selected from:

4,12-di-n-butyl-1,7,9,15-tetraoxa-4,12-diaza-8-stannaspiro[7.7]pentadecane,

4,12-di-n-butyl-2,6,10,14-tetramethyl-1,7,9,15-teraoxa-4,12-diaza-8-stannaspiro[7.7]pentadecane,

2,4,6,10,12,14-hexamethyl-1,7,9,15-teraoxa-4,12-diaza-8-stannaspiro[7.7]pentadecane,

4,12-di-n-octyl-2,6,10,14-tetramethyl-1,7,9,15-tetraoxa-4,12-diaza-8-stannaspiro[7.7]pentadecane,

4,12-di-n-octyl-1,7,9,15-tetraoxa-4,12-diaza-8-stannaspiro[7.7]pentadecane,

4,12-dimethyl- 1,7,9,15-tetraoxa-4,12-diaza- 8-stannaspiro [7.7]pentadecane,

1,1-dichloro-5-methyl-5-aza-2,8-dioxa-1-stannacyclooctane or mixtures thereof.

The thermally latent catalysts can be combined with further catalysts/activators known from the prior art; for example titanium, zirconium, bismuth, tin(II) and/or iron catalysts, as described, for example, in WO 2005/058996. It is also possible to add amines or amidines. In addition, in the polyisocyanate polyaddition reaction, it is also possible to add acidic compounds, for example 2-ethylhexanoic acid, or alcohols to control the reaction.

Substrates suitable for the process of the invention are, for example, substrates comprising one or more materials, especially including what are called composite materials. A substrate formed from at least two materials is referred to in accordance with the invention as composite material. Suitable materials are, for example, wood, metal, plastic, paper, leather, textiles, felt, glass, woodbase materials, cork, inorganically bound substrates such as wood and fiber cement boards, electronic assemblies or mineral substrates. Suitable types of composite material are, for example, particle composite materials, also referred to as dispersion materials, fiber composite materials, laminar composite materials, also referred to as laminates, penetration composite materials and structural composite materials.

Suitable metals are, for example, steel, aluminium, magnesium and alloys of metals as used in the applications of wire coating, coil coating, can coating or container coating, and the like.

In the context of the invention, the term plastic also comprehends fiber-reinforced plastics, for example glass- or carbon fiber-reinforced plastics, and plastics blends composed of two or more plastics.

Examples of plastics suitable in accordance with the invention are ABS, AMMA, ASA, CA, CAB, EP, UF, CF, MF, MPF, PF, PAN, PA, PE, HDPE, LDPE, LLDPE,

UHMWPE, PET, PMMA, PP, PS, SB, PUR, PVC, RF, SAN, PBT, PPE, POM, PUR-RIM, SMC, BMC, PP-EPDM and UP (abbreviations according to DIN 7728T1). These may also be in the form of films or in the form of glass fiber- or carbon fiber-reinforced plastics.

For use in step a) of the process of the invention, the substrates may be uncoated or coated. It is possible that primers and/or primer-surfacers, for example, have already been applied to the substrate as coating before it is used in the process of the invention. Examples of primers are especially cathodic dip coats as used in OEM automobile finishing, solventborne or aqueous primers for plastics, especially for plastics having low surface tension, such as PP or PP-EPDM.

In one embodiment of the invention, the substrate to be provided in accordance with the invention in step a) is a chassis or parts thereof which comprise(s) one or more of the aforementioned materials. Preferably, the chassis or parts thereof comprise(s) one or more of the materials selected from metal, plastic or mixtures thereof.

In a further embodiment of the process of the invention, the substrate comprises metal; more particularly, the substrate may consist of metal to an extent of 80% by weight, 70% by weight, 60% by weight, 50% by weight, 25% by weight, 10% by weight, 5% by weight, 1% by weight.

In a preferred embodiment of the process of the invention, the substrate consists at least partly of a composite material, especially of a composite material comprising metal and/or plastic.

The at least one basecoat layer and the at least one clearcoat and/or topcoat layer can be applied to the substrate in steps a) and b) of the process of the invention from solution, dispersion in a liquid dispersant such as water, or from the melt, and in the case of powder coatings in solid form. Preference is given to application from solution. Suitable methods of application are, for example, printing, painting, rolling, casting, dipping, fluidized bed methods and/or preferably spraying, for example compressed air spraying, airless spraying, high rotation, electrostatic spray application (ESTA), optionally combined with hot spray application, for example hot-air spraying.

The number of basecoat layers to be applied in step a) and of clearcoat and/or of topcoat layers to be applied in step b) is not limited to one layer. In step a), it is consequently also possible to apply two, three, four or more basecoat layers. It is likewise possible in the context of the invention, in step b) of the process of the invention, to apply two, three, four or more clearcoat and/or topcoat layers.

In order to facilitate the application of the basecoat layer in step a) and of the clearcoat and/or topcoat layer in step b), as the case may be, the NCO-reactive compound and/or the polyisocyanate may be present in a suitable solvent. Suitable solvents are those which have sufficient solubility for the NCO-reactive compound and/or the polyisocyanate and are free of groups reactive toward isocyanates. Examples of such solvents are acetone, methyl ethyl ketone, cyclohexanone, methyl isobutyl ketone, methyl isoamyl ketone, diisobutyl ketone, ethyl acetate, n-butyl acetate, ethylene glycol diacetate, butyrolactone, diethyl carbonate, propylene carbonate, ethylene carbonate, N,N-dimethylformamide, N,N-dimethylacetamide, N-methylpyrrolidone, N-ethylpyrrolidone, methylal, ethylal, butylal, 1,3-dioxolane, glycerol formal, benzene, toluene, n-hexane, cyclohexane, Solvent naphtha, 2-methoxypropyl acetate (MPA). In addition, the NCO-reactive compound in step a) may also be present in solvents bearing isocyanate-reactive groups. Examples of such reactive solvents are those which have a mean functionality of groups reactive toward isocyanates of at least 1.8. These may be, for example, low molecular weight diols (e.g. ethane-1,2-diol, propane-1,3- or -1,2-diol, butane-1,4-diol), triols (e.g. glycerol, trimethylolpropane), but also low molecular weight diamines, for example polyaspartic esters.

It has been found to be particularly appropriate in practice when, after the application of the at least one basecoat layer in step a) and before the application of the at least one clearcoat and/or topcoat layer in step b), the formation of a film and the departure of the major portion of any solvent and/or water present from the film is awaited. According to the application and drying apparatus available, the optimal wait time can be determined in simple experiments. The film formation and the departure of solvent and/or water from the film should have advanced just to such an extent that the clearcoat or topcoat applied in step b) no longer leads to true partial dissolution and a change in the appearance of the basecoat. Especially in the case of metallic effect basecoats, the alignment of the metallic effect pigments can be disrupted by excessively early application of a clearcoat and can therefore lead to a reduction in the flip-flop effect and/or to graying. If the drying or curing of the basecoat has advanced too far, it is more difficult for the hardener to diffuse into the basecoat.

The clearcoat and/or topcoat to be applied in step b), comprising at least one polyisocyanate and at least one NCO-reactive compound, can either be applied after the mixing of the clearcoat and/or topcoat components or mixed directly on application. In the first case, the mixed clearcoat and/or topcoat has a limited useful life, called the pot life, since the crosslinking reaction already proceeded gradually after the mixing. In the context of the invention, the pot life is defined as the time within which paint has doubled its viscosity (determined indirectly by doubling the efflux time in the DIN cup, 4 mm).

As step c), the process of the invention quite generally provides for the formation of a film. During the film formation phase in step c), there is coagulation and film formation of the clearcoat and topcoat applied to the substrate. Any solvent and/or water present gradually leaves the film by evaporation. This operation can be accelerated by heat supplied or air flow at the surface of the coating. This shrinks the film. Typically, in parallel with the evaporation of the solvent, the crosslinking reaction of the at least one polyisocyanate with the at least one NCO-reactive compound in the clearcoat and/or topcoat commences. Especially the supply of heat or catalytically active paint constituents can accelerate the crosslinking reaction. In the context of the invention, it is essential that the cros slinking reaction does not proceed during the film formation phase, or proceeds only to such a slow degree that the polyisocyanates are not significantly crosslinked, if at all, in order that they are capable of diffusing into the basecoat. It can take 30 seconds to 12 minutes in the process of the invention for the film to form in step c) and for any solvents and/or water present to have essentially left the film. “Essentially” means that more than 60%, preferably more than 85% and more preferably more than 95% of the amount of solvent and/or water used has left the film. Preferably, the film formation phase in step c) of the process of the invention is complete after 1 to 5 minutes, more preferably after 2 to 3 minutes. There is preferably a wait for at least 30, 45, 60, 120, 180 or 300 s in step c), so that a film has been able to form prior to the curing in step d).

It has been found to be particularly appropriate in practice for the process of the invention when the curing in step d) is effected at a substrate temperature of below 120° C., preferably below 110° C., more preferably below 100° C., especially below 90° C.

The curing in step d) of the process of the invention is advantageously essentially complete within less than 45 minutes. Preferably, the curing in step d) is essentially complete within less than 40 minutes, more preferably less than 35 minutes, most preferably within less than 30 minutes.

“Essentially complete” as used here means that the residual isocyanate content after the curing in step d) is less than 20%, preferably less than 15%, especially preferably less than 10%, more preferably less than 5%, even more preferably less than 3%, based on the isocyanate content of the polyisocyanate in step b). The percentage of isocyanate groups still present can be determined by comparison of the content of isocyanate groups in % by weight in step b) with the content of isocyanate groups in % by weight after the curing in step d), for example by comparison of the intensity of the isocyanate band at about 2270 cm⁻¹ by means of IR spectroscopy.

In a particular embodiment of the process of the invention, step d) may be followed by a further step e) in which the multilayer paint system is detached again from the substrate in order to produce a film.

The invention further provides a multilayer paint system obtainable by the process of the invention. It has especially been found that the multilayer paint systems produced by the process of the invention using a thermally latent catalyst are materially and physically different than the dibutyltin dilaurate-catalyzed systems known from the prior art. More particularly, they have improved interlayer adhesion.

The invention further provides for the use of the multilayer paint system obtainable by the process of the invention for coating of substrates, and substrates obtainable thereby that have been coated with the multilayer paint system of the invention.

In a preferred embodiment of the invention, the substrate coated with the multilayer paint system of the invention may be a chassis, especially of a vehicle. The vehicle may be formed from one or more materials. Suitable materials are, for example, metal, plastic or mixtures thereof. The vehicle may be any vehicle known to those skilled in the art. For example, the vehicle may be a motor vehicle, heavy goods vehicle, motorcycle, moped, bicycle or the like. Preferably, the vehicle is a motor vehicle and/or heavy goods vehicle, more preferably a motor vehicle.

In a further preferred embodiment of the invention, the substrate coated with the multilayer paint system of the invention is a chassis or parts thereof which comprise(s) one or more of the materials selected from metal, plastic and mixtures thereof.

The invention is elucidated in detail hereinafter by examples.

### EXAMPLES

Substances Used:

The raw materials, unless stated otherwise, were used without further purification or pretreatment.

OH-containing acrylate polyol (Covestro, DE), DMEA: N,N-dimethylethanolamine, neutralizing agent (Aldrich, DE), 2-ethyl-1-hexanol: CAS 104-76-7, cosolvent (Aldrich, DE), BYK 347: silicone surfactant for improvement of substrate wetting (Byk Chemie GmbH, DE), BYK 345: silicone surfactant for improvement of substrate wetting (BYK Chemie GmbH, DE), BYK 011: defoamer (Byk Chemie GmbH, DE), BYKETOL AQ: silicone-free surface additive for prevention of popping and blisters (Byk Chemie GmbH, DE), SOLUS 3050: thickener based on cellulose acetobutyrate (Eastman, US), RHEOVIS AS 1130: thickener, anionic polyacrylate copolymer, (BASF, DE), n-butanol: 1-butanol, CAS 71-36-3, cosolvent (Aldrich, DE), SETAQUA D E 270: water-thinnable polyester (Nuplex, DE), BORCHI GEN 0851: pigment wetter and dispersing additive (OMG Borchers, DE), COLOR BLACK FW 200: lamp black, pigment (Evonik Degussa, DE), SETALUX 1774 SS-65: OH-containing acrylate polyol (Nuplex, NL), BYK 331: polyether-modified polydimethylsiloxane, leveling agent (Byk Chemie GmbH, DE), DBTL: dibutyltin dilaurate, catalyst, CAS 77-58-7 (Aldrich, DE), MPA: 1-methoxy-2-propyl acetate, CAS 108-65-6, solvent (BASF, DE), Solvent naphtha light: Solvent naphtha 100, SN 100, CAS 64742-95-6, solvent, (Azelis, BE), DESMODUR N 3390 BA, crosslinker, HDI trimer (Covestro, DE), butyl acetate: n-butyl acetate, CAS 123-86-4, solvent (BASF, DE), SETAQUA 6803: acrylate polyol (Nuplex, NL), BAYHYDROL UA 2856 XP: acrylate-modified polyurethane dispersion (Covestro, DE), BAYHYDROL UH 2606: polyurethane dispersion (Covestro, DE).

Migration Experiments By Means of IR-ATR

Basecoat Formulation

In order to detect the migration of polyisocyanate into the basecoat, an aqueous basecoat, black, based on a secondary acrylate (OH-containing) was prepared. For this purpose, the components were weighed out successively, mixed and, as specified in the formulation, dispersed with a dissolver having a dispersing disk.

| | 1 |
|---|---|
| I.) BAYHYDROL A 2542, as supplied | 34.81 |
| Demineralized water | 25.25 |
| Dimethylethanolamine, 10% in demineralized water | 6.02 |
| (for pH 8-8.5) | |
| 2-Ethyl-1-hexanol | 2.79 |
| BYK 347, as supplied | 0.17 |
| BYK 345, as supplied | 0.17 |
| BYK 011, as supplied | 1.45 |
| BYKETOL AQ, as supplied | 2.76 |
| SOLUS 3050, 20% in butylglycol/demineralized water/ | 2.61 |
| DMEA (50.00/28.58/1.42) | |
| RHEOVIS AS 1130, as supplied | 1.75 |
| n-Butanol | 0.14 |

- disperse at about 10.5 m/s for 5 min. -

| II.) Pigment paste, black, consisting of: | | 6.20 |
|---|---|---|
| SET AQUA B E 270, as supplied | 10.40 | |
| Demineralized water | 41.60 | |
| BORCHI GEN 0851, as supplied | 32.00 | |
| COLOR BLACK FW 200 | 16.00 | |

- disperse at about 10.5 m/s for 30 min. -

| | |
|---|---|
| III.) Demineralized water | 15.88 |
| Total weight | 100.00 |
| Solids content at spray viscosity | 21.7% |
| DIN cup efflux time, 4 mm | 30 s |
| pH | about 8.3 |

Clearcoat Formulation

The clearcoat test formulations were calculated such that the polyisocyanate is present 10% in excess. The amount of the leveling agent added was calculated based on the solid resin content. The amount of catalyst was calculated in “ppm of tin based on the solid resin content of the polyisocyanate”. The coating materials were produced by mixing the binders with the additives and stirring the mixture at room temperature. The solvent used was 1-methoxyprop-2-yl acetate/Solvent naphtha light (1:1). The amounts of solvent were chosen such that the theoretical solids content was the same.

| | 1 | 2 | 3 | 4 |
|---|---|---|---|---|
| A.) SETALUX 1774 SS-65, as supplied | 100.00 | 100.00 | 100.00 | 100.00 |
| BYK-331, as supplied | 0.11 | 0.11 | 0.11 | 0.11 |
| DBTL, 10% in 1-methoxyprop-2-yl acetate | | 1.10 | 2.19 | |
| 4,12-Di-n-butyl-2,6,10,14-tetramethyl- | | | | 1.06 |
| 1,7,9,15-tetraoxa-4,12-diaza-8- | | | | |
| stannaspiro[7.7]pentadecane, supplied | | | | |
| in 16.2% form in butyl acetate | | | | |
| 1-Methoxyprop-2-yl acetate/Solvent | 31.29 | 30.37 | 29.46 | 30.51 |
| naphtha light (1:1) | | | | |
| B.) DESMODUR N 3390 BA - as supplied | 45.76 | 45.76 | 45.76 | 45.76 |
| Total weight | 177.16 | 177.34 | 177.52 | 177.44 |
| Solids content (theo.), in % by wt. | 60.0 | 60.0 | 60.0 | 60.0 |
| Tin content based on solid resin | — | 500 ppm | 1000 ppm | 1000 ppm |
| content of the polyisocyanate | | from | from | from |
| | | DBTL | DBTL | lat. cat. |

Legend: lat. cat. = thermally latent catalyst; DBTL = dibutyltin dilaurate.

Migration Experiments

For the migration experiments, the basecoat was drawn down onto a PP sheet by means of a 50 μm spiral coating bar and dried in an air circulation paint drying cabinet at 80° C. for 20 min. Immediately after being cooled down (RT for 20 min.), the clearcoat to be tested was then applied to the basecoat by means of spray application, flashed off at room temperature for 5 minutes in order to enable film formation, and then baked in an air circulation paint drying cabinet at 100° C. for 30 min. The layer thicknesses of the basecoat and of the clearcoat are identical in all experimental systems (basecoat layer thickness: 12-14 μm, clearcoat layer thickness: about 40 μm).

Within the cooling time (RT for 15 min.), the paint system was pulled off the PP sheet and then the basecoat was analyzed on its underside by means of an FT-IR spectrometer (Tensor II with platinum ATR unit (diamond crystal) from Bruker). Triple measurements were conducted.

The following peaks were evaluated:
Isocyanurate peak shoulder (1686 cm⁻¹)
Isocyanurate peak A (1462 cm⁻¹)
Isocyanurate peak B (763 cm⁻¹)

| | 1 | 2 | 3 | 4 |
|---|---|---|---|---|
| Tin content based on | — | 500 ppm | 1000 ppm | 1000 ppm |
| solid resin content of | | from | from | from |
| the polyisocyanate | | DBTL | DBTL | lat. cat. |

Isocyanurate peak shoulder (1686 cm⁻¹)

| | | | | |
|---|---|---|---|---|
| Height on the Y axis | 0.313 | 0.201 | 0.099 | 0.275 |
| [absorbance units] | | | | |

Isocyanurate peak A (1462 cm⁻¹)

| | | | | |
|---|---|---|---|---|
| Integrated area from 1488 | 6.633 | 4.707 | 3.279 | 5.978 |
| cm⁻¹ to 1415 cm⁻¹ | | | | |
| [area] | | | | |

Isocyanurate peak B (763 cm⁻¹)

| | | | | |
|---|---|---|---|---|
| Integrated area from 782.5 | 2.810 | 2.564 | 2.346 | 2.752 |
| cm⁻¹ to 717.7 cm⁻¹ | | | | |

Legend: lat. cat. = thermally latent catalyst; DBTL = dibutyltin dilaurate.

It was demonstrated that the thermally latent catalyst, compared to DBTL, enables greater migration of isocyanate through the overall basecoat layer, which can be seen from the greater peak areas/absorbance units measured on the underside of the basecoat.

Other Experiments

Decrease in NCO

The reaction kinetics of the crosslinking were examined by means of the decrease in NCO.

For this purpose, the clearcoat test formulations were calculated such that the polyisocyanate has been crosslinked with a polyol in an equimolar ratio. The amount of the leveling agent added was calculated based on the solid resin content. The amount of catalyst was calculated in “ppm of tin based on the solid resin content of the polyisocyanate”. The coating materials were produced by mixing the binders with the additives and stirring the mixture at room temperature. The solvent used was 1-methoxyprop-2-yl acetate/Solvent naphtha light (1:1). The amounts of solvent were chosen such that the theoretical solids contents were the same.

| | 4 | 8 | 7 | 6 |
|---|---|---|---|---|
| Tin content based on | — | 500 ppm | 500 ppm | 1000 ppm |
| solid resin content of | | from | from | from |
| the polyisocyanate | | DBTL | lat. cat. | lat. cat. |
| Component A | | | | |
| SETALUX 1774 SS-65, as | 53.45 | 53.45 | 53.45 | 53.45 |
| supplied | | | | |
| BYK 331, 10% in butyl | 0.58 | 0.58 | 0.58 | 0.58 |
| acetate | | | | |
| 1-Methoxyprop-2-yl | 10.97 | 10.97 | 10.97 | 10.97 |
| acetate/Solvent naphtha | | | | |
| light (1:1) | | | | |
| Component B | | | | |
| DESMODUR N 3390 BA, | 21.92 | 21.92 | 21.92 | 21.92 |
| as supplied | | | | |
| Butyl acetate | 0.28 | 0.27 | 0.23 | 0.18 |
| Solvent naphtha light | 2.47 | 2.43 | 2.05 | 1.63 |
| 4,12-Di-n-butyl- | | | 0.47 | 0.94 |
| 1,7,9,15-tetraoxa-4,12- | | | | |
| diaza-8- | | | | |
| stannaspiro[7.7]pen- | | | | |
| tadecane | | | | |
| Dibutyltin dilaurate | | 0.05 | | |
| 1-Methoxyprop-2-yl | 10.33 | 10.33 | 10.33 | 10.33 |
| acetate/Solvent naphtha | | | | |
| light (1:1) | | | | |
| Total | 100.00 | 100.00 | 100.00 | 100.00 |
| Solids content | 54.5% | 54.5% | 54.5% | 54.5% |

Legend: lat. cat. = thermally latent catalyst; DBTL = dibutyltin dilaurate.

The test paints were applied to silica plaques (=specimens) and, immediately after application, analyzed with an FT-IR spectrometer (Vector 33 with HTS-XT microtiter module for transmission measurements from Bruker). Thereafter, the test specimens were dried at 100° C. in an air circulation paint drying cabinet for 30 minutes and then analyzed again immediately after the baking process and after defined storage periods. For characterization of the reaction kinetics, the intensity of the NCO peak (at wavelength 2274 cm⁻¹) was monitored, setting the first measurement after mixing of the components and application at a starting value to 100%. All further measurements (after thermal treatment and/or storage) are then calculated relative to the starting value. The results (relative change in the intensity of the NCO peaks in %) are reported in the following table:

| | | | | | System |
|---|---|---|---|---|---|
| | System | 500 ppm | 500 ppm | 1000 ppm | without |
| | without | Sn from | Sn from | Sn from | cat. (140° C. |
| | cat. | DBTL | lat. cat. | lat. cat. | 30 min.) |
| After | 100.0% | 100.0% | 100.0% | 100.0% | 100.0% |
| application | | | | | |
| After drying | 33.5% | 17.9% | 20.9% | 10.3% | 12.5% |
| at 100° C. | | | | | |
| for 30 min. | | | | | |
| After | 31.2% | 16.8% | 19.4% | 9.5% | 12.2% |
| standard | | | | | |
| climatic | | | | | |
| conditions | | | | | |
| for 1 h | | | | | |
| After | 23.6% | 13.9% | 14.8% | 7.9% | 11.0% |
| standard | | | | | |
| climatic | | | | | |
| conditions | | | | | |
| for 24 h | | | | | |
| After ageing | 1.5% | 1.2% | 0.7% | 0.4% | 3.0% |
| at 60° C. | | | | | |
| for 16 h | | | | | |

Legend: lat. cat. = thermally latent catalyst; cat. = catalyst; DBTL = dibutyltin dilaurate.

The evaluations show that a standard system under current process conditions (drying at 140° C. for 30 minutes) has about 12% residual NCO after the baking process and, with this degree of crosslinking, would meet the demands on chemical resistance and scratch resistance, for example. The same clearcoat system without catalyst still has about 34% residual NCO after drying at 100° C. for 30 minutes and would not meet these demands. This indicates that low-temperature clearcoats do not crosslink sufficiently without appropriate thermally latent catalysis. By contrast, with the clearcoat system having thermally latent catalysis, it is possible to achieve or even go lower than the required residual NCO content of 12%.

Bonding Experiments

The bonding of the multilayer paint system on a PC/ABS blend (Bayblend T85 XF) was examined. For this purpose, an aqueous basecoat, black, was produced, for which the components were weighed out successively, mixed and, as specified in the formulation, dispersed appropriately with a dissolver having a dispersing disk.

| | | 4 |
|---|---|---|
| I.) SETAQUA 6803, as supplied | | 25.72 |
| BAYHYDROL UA 2856 XP, as supplied | | 13.23 |
| BAYHYDROL UH 2606, as supplied | | 13.23 |
| Dimethylethanolamine, 10% in demineralized H₂O | | 4.15 |
| (for pH 8-8.5) | | |
| 2-Ethyl-1-hexanol | | 2.47 |
| BYK 347, as supplied | | 0.15 |
| BYK 345, as supplied | | 0.15 |
| BYK 011, as supplied | | 1.30 |
| BYKETOL AQ, as supplied | | 2.44 |
| n-Butanol | | 0.12 |
| Pigment paste, black, consisting of: | | 5.50 |
| SETAQUA B E 270, as supplied | 10.40 | |
| Demineralized water | 41.60 | |
| BORCHI GEN 0851, as supplied | 32.00 | |
| COLOR BLACK FW 200 | 16.00 | |

| | |
|---|---|
| SOLUS 3050, 20% in butylglycol/demineralized water/DMEA | 1.54 |
| (50.00/28.58/1.42) | |
| RHEOVIS AS 1130, as supplied | 1.03 |
| Demineralized water | 7.20 |

disperse at about 10.5 m/s for 30 min

| | |
|---|---|
| II.) Demineralized water | 21.77 |
| Total weight | 100.00 |
| Solids content at spray viscosity | 18.9% |
| Efflux time, DIN cup, 4 mm | 30 s |
| pH | about 8.3 |

The clearcoat test formulations were calculated such that the polyol is present 10% in excess. The amount of the leveling agent added was calculated based on the solid resin content. The amount of catalyst was calculated in “ppm of tin based on the solid resin content of the polyisocyanate”. The coating materials were produced by mixing the binders with the additives and stirring the mixture at room temperature. The solvent used was 1-methoxyprop-2-yl acetate/Solvent naphtha light (1:1). The amounts of solvent were chosen such that the solids contents were the same.

| | 18 | 19 | 20 | 21 |
|---|---|---|---|---|
| A.) SETALUX 1774 SS-65, as supplied | 100.00 | 100.00 | 100.00 | 100.00 |
| BYK-331, as supplied | 0.25 | 0.25 | 0.25 | 0.25 |
| Dibutyltin dilaurate, 10% in MPA | | 0.90 | 1.79 | |
| 1-Methoxyprop-2-yl acetate/Solvent naphtha | 27.22 | 26.47 | 25.73 | 26.59 |
| light (1:1) | | | | |
| B.) DESMODUR N 3390 BA, as supplied | 37.44 | 37.44 | 37.44 | 37.44 |
| 4,12-Di-n-butyl-2,6,10,14-tetramethyl- | | | | 0.86 |
| 1,7,9,15-tetraoxa-4,12-diaza-8- | | | | |
| stannaspiro[7.7]pentadecane, supplied | | | | |
| in 16.2% form in BA | | | | |
| Total weight | 164.91 | 165.06 | 165.21 | 165.14 |
| Solids content | 60.0% | 60.0% | 60.0% | 60.0% |
| Tin content based on solid resin | — | 500 ppm | 1000 ppm | 1000 ppm |
| content of the polyisocyanate | | from | from | from |
| | | DBTL | DBTL | lat. cat. |

Legend: lat. cat. = thermally latent catalyst; DBTL = dibutyltin dilaurate.

For the experiments, the basecoat was drawn down onto a BAYBLEND T85 XF sheet by means of a 50 p.m spiral coating bar and dried in an air circulation paint drying cabinet at 80° C. for 10 min. Immediately after being cooled down (room temperature for 20 min.), the clearcoat to be tested was then applied to the basecoat, likewise by means of a 50 μm spiral coating bar, flashed off at room temperature for 10 minutes, and then baked in an air circulation paint drying cabinet at 100° C. for 30 min. Before the bonding test, the sheet material was aged at 60° C. for another 16 hours. The layer thicknesses of the basecoat and of the clearcoats are identical in all experimental systems (layer thickness of the basecoats: 12 μm-13 μm, layer thickness of the clearcoats: 30-34 μm).

For the bonding test, the coated sheet material was stored in water at 95° C. to 98° C. for 1 h and then regenerated under standard climatic conditions for 4 hours. Then the bonding was tested by means of a crosscut test with a multiblade knife according to DIN EN ISO 2109 (blade separation 1 mm and 2 mm). Loose particles were removed with “Scotch Pressure Sensitive Tape” adhesive tape from 3M, which was rubbed onto the cut grid by thumbnail and abruptly pulled off the coating in the vertically upward direction as far as possible. The damage was inspected with a magnifying glass and assessed with reference to the crosscuts depicted in the DIN standard. GT 0 means that the crosscuts are completely smooth and that no fragments have flaked off.

Subsequently, what is called the coin test was conducted at another site. For this purpose, a sharp-edged coin was used to scratch the paint down to the plastic substrate and then the surfaces exposed were assessed with a magnifying glass. The force expended should be chosen such that the coin penetrates into the paint down to the substrate, such that the substrate is always visible after the coin has been pulled out. Evaluation: “OK” means that no shiny areas have been exposed, which indicates good (interlaminar) adhesion, “partly OK” means that small shiny areas have been exposed, “not OK” indicates delamination over a large area.

| | 18 | 19 | 20 | 21 |
|---|---|---|---|---|
| Tin content based on | — | 500 ppm | 1000 ppm | 1000 ppm |
| solid resin content of | | from | from | from |
| the polyisocyanate | | DBTL | DBTL | lat. cat. |
| Adhesion after boil test | | | | |
| Crosscut, distance 1 mm | GT 0 | GT 0 | GT 0 | GT 0 |
| Crosscut, distance 2 mm | GT 0 | GT 0 | GT 0 | GT 0 |
| Coin test | not OK | not OK- | partly OK | OK |
| | | partly OK | | |

Legend: lat. cat. = thermally latent catalyst; DBTL = dibutyltin dilaurate.

All systems exhibited very good adhesion in the crosscut test. The uncatalyzed system failed in the coin test since the crosslinking operation was still incomplete and the system did not have sufficient film hardness. The system comprising thermally latent hardener exhibited very good intermediate adhesion; the systems comprising DBTL showed the expected disadvantages to be expected as a result of lower NCO migration.

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant reserves the right to amend the claims during prosecution to add features as variously described in this specification, and such amendments comply with the requirements of 35 U.S.C. § 112(a), and 35 U.S.C. § 132(a).

1. A process for producing a multilayer paint system, comprising the following steps:
a) applying to a substrate at least one basecoat layer, the basecoat layer being essentially free of melamine and derivatives thereof;
b) applying to the substrate at least one clearcoat and/or topcoat layer, comprising at least one polyisocyanate, at least one NCO-reactive compound and at least one thermally latent catalyst;
c) waiting for at least 30 s after step b) to allow a film to form;
d) curing the multilayer paint system with heat.

2. The process as claimed in claim 1, wherein the substrate comprises metal.

3. The process as claimed in claim 1, wherein the basecoat layer comprises at least one NCO-reactive compound.

4. The process as claimed in claim 1, characterized wherein the NCO-reactive compound present in the basecoat layer and/or the clearcoat and/or topcoat layer is a polyhydroxyl compound.

5. The process as claimed in claim 1, wherein the polyisocyanate present in the clearcoat and/or topcoat layer is an aliphatic and/or cycloaliphatic polyisocyanate.

6. The process as claimed in claim 1, wherein the polyisocyanate present in the clearcoat and/or topcoat layer is a derivative of hexamethylene diisocyanate and/or of pentamethylene diisocyanate.

7. The process as claimed in claim 1, wherein the polyisocyanate present in the clearcoat and/or topcoat layer is a hexamethylene diisocyanate trimer and/or a pentamethylene diisocyanate trimer.

8. The process as claimed in claim 1, characterized wherein the thermally latent catalyst used in the clearcoat and/or topcoat layer comprises cyclic tin compounds of the formula I, II or III or mixtures thereof: 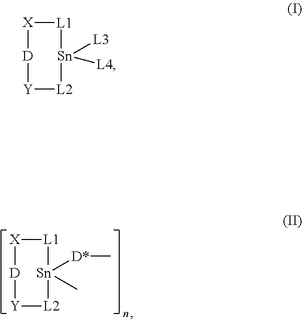
with n>1, 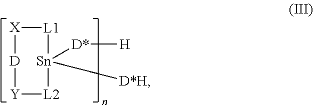
with n>1,
where:
D is —O—, —S— or —N(R1)-
where R1 is a saturated or unsaturated, linear or branched, aliphatic or cycloaliphatic radical or an optionally substituted aromatic or araliphatic radical which has up to 20 carbon atoms and may optionally contain heteroatoms from the group of oxygen, sulfur, nitrogen, or is hydrogen or the radical 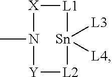
or R1 and L3 together are —Z-L5-;
D* is —O— or —S—; X, Y and Z are identical or different radicals selected from alkylene radicals of the formulae —C(R2)(R3)-, —C(R2)(R3)-C(R4)(R5)- or —C(R2)(R3)-C(R4)(R5)-C(R6)(R7)- or ortho-arylene radicals of the formulae 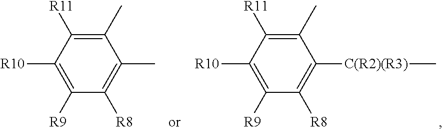
where R2 to R11 are independently saturated or unsaturated, linear or branched, aliphatic or cycloaliphatic or optionally substituted aromatic or araliphatic radicals which have up to 20 carbon atoms and may optionally contain heteroatoms from the group of oxygen, sulfur, nitrogen, or are hydrogen;
L1, L2 and L5 are independently —O—, —S—, —OC(═O)—, —OC(═S), —SC(═O)—, —SC(═S)—, —OS(═O)₂O—, —OS(═O)₂— or —N(R12)-,
where R12 is a saturated or unsaturated, linear or branched, aliphatic or cycloaliphatic radical or an optionally substituted aromatic or araliphatic radical which has up to 20 carbon atoms and may optionally contain heteroatoms from the group of oxygen, sulfur, nitrogen, or is hydrogen;
L3 and L4 are independently —OH, —SH, —OR13, -Hal, —OC(═O)R14, —SR15, —OC(═S)R16, —OS(═O)₂OR17, —OS(═O)₂R18 or —NR19R20, or L3 and L4 together are -L1-X-D-Y-L2-,
where R13 to R20 are independently saturated or unsaturated, linear or branched, aliphatic or cycloaliphatic or optionally substituted aromatic or araliphatic radicals which have up to 20 carbon atoms and may optionally contain heteroatoms from the group of oxygen, sulfur, nitrogen, or are hydrogen.

9. The process as claimed in claim 1, wherein the curing in step d) is effected at a substrate temperature below 120° C.

10. The process as claimed in claim 1, wherein the curing in step d) is essentially complete within less than 45 minutes.

11. The process as claimed in claim 1, wherein the residual isocyanate content after the curing in step d) is less than 20% based on the isocyanate content of the polyisocyanate in step b).

12. A multilayer paint system obtained by the process as claimed in claim 1.

13. A process of coating a substrate comprising applying the multilayer paint system as claimed in claim 12.

14. A substrate coated with a multilayer paint system as claimed in claim 1, wherein the substrate comprises a chassis, of a vehicle, or parts thereof.

15. The substrate as claimed in claim 14, wherein the chassis or parts thereof comprise(s} one or more of the materials selected from the group consisting of metal, plastic or mixtures thereof.
